(19) United States
(12) Patent Application Publication
(10) Pub. No.: US 2025/0223864 A1
(43) Pub. Date: Jul. 10, 2025

(54) INSOLATION STRUCTURE AND DOOR AND WINDOW INSULATION STRUCTURE

(71) Applicant: Guangdong Bucalu Curtain Wall Window & Door System Co., Ltd., Qingyuan (CN)

(72) Inventor: Fandong MENG, Qingyuan (CN)

(73) Assignee: Guangdong Bucalu Curtain Wall Window & Door System Co., Ltd., Qingyuan (CN)

(21) Appl. No.: 19/006,243

(22) Filed: Dec. 31, 2024

(30) Foreign Application Priority Data
Jan. 5, 2024 (CN) 202420032119.6
Jan. 5, 2024 (CN) 202420032124.7

(51) Int. Cl. E06B 3/263; E06B 3/46; E06B 7/16

(52) U.S. Cl. CPC E06B 3/26347; E06B 3/46; E06B 7/16

(57) ABSTRACT

Insulation structure includes main-body assembly and side frame including frame body and thermal insulation assembly arranged in frame body. Thermal insulation assembly includes first sectional material, compensating member, and second sectional material connected in sequence. Main-body assembly is arranged on frame body. Thermal insulation assembly is arranged in length direction of frame body. First sectional material is located indoors. Second sectional material is located outdoors. Door and window insulation structure includes side frame and main body portion arranged on and slidingly connected to side frame including frame body and multiple first fixing parts arranged at intervals and all arranged on frame body. Main body portion includes main body and multiple second fixing parts arranged at intervals and all arranged on main body. One first fixing part is correspondingly inserted between two adjacent second fixing parts, and one second fixing part is correspondingly inserted between two adjacent first fixing parts.

### CROSS-REFERENCE TO RELATED APPLICATION

The present disclosure claims priority to Chinese Patent Application No. 2024200321247 filed with the Chinese Patent Office on Jan. 5, 2024, entitled “INSOLATION STRUCTURE”, and priority to Chinese Patent Application No. 2024200321196 filed with the Chinese Patent Office on Jan. 5, 2024, entitled “DOOR AND WINDOW INSULATION STRUCTURE”, the entire contents of which are incorporated by reference in the present disclosure.

### TECHNICAL FIELD

The present disclosure relates to the field of the door and window manufacturing, and specifically to an insulation structure and a door and window insulation structure.

### BACKGROUND ART

When the traditional window and door are in a closed state, one end of the partial sectional material on the side frame is located indoors, and the other end is located outdoors. The indoor heat is easily transmitted from one end located indoors to the other end located outdoors via the partial sectional material, or the outdoor heat is easily transmitted from one end located outdoors to the other end located indoors via the partial sectional material, which results in a poorer thermal insulation performance of the door and window.

Additionally, the traditional sliding door and window have cavities formed between the side frame and the door and window, so that the heat between the outdoors and the indoors can be simply transferred quickly by the sectional material located outdoors, the cavities, and the sectional material located indoors, so as to affect the thermal insulation performance of the door and window.

### SUMMARY

Based on this, in order to solve the problem that partial sectional materials of the traditional door and window are easy to lead to the phenomenon of the fast indoor and outdoor heat transfer, which results in a reduction of the thermal insulation performance of the door and window, and the problem that the traditional door and window has the cavities formed between the side frame and the door and window, which results in the poorer thermal insulation performance of the door and window, the present disclosure provides an insulation structure and a door and window insulation structure. The specific technical solutions are as follows.

In a first aspect, the present disclosure provides an insulation structure, including:

a main-body assembly; and

a side frame, wherein the side frame includes a frame body and a thermal insulation assembly arranged in the frame body; the thermal insulation assembly includes a first sectional material, a compensating member, and a second sectional material connected in sequence; the main-body assembly is arranged on the frame body; and the thermal insulation assembly is arranged in a length direction of the frame body, wherein the first sectional material is located indoors, and the second sectional material is located outdoors.

In a second aspect, the present disclosure further provides a door and window insulation structure, including:

a side frame; and

a main body portion, wherein the main body portion is arranged on the side frame and slidingly connected to the side frame; the side frame includes a frame body and a plurality of first fixing parts arranged at intervals and all arranged on the frame body; and the main body portion includes a main body (the main-body assembly) and a plurality of second fixing parts arranged at intervals and all arranged on the main body, wherein one of the first fixing parts is correspondingly inserted between two adjacent second fixing parts, and one of the second fixing parts is correspondingly inserted between two adjacent first fixing parts.

In the above insulation structure, the first sectional material and the second sectional material are disconnected by the compensating member, which avoids the direct heat transfer between the first sectional material and the second sectional material, so as to solve the problem that the partial sectional materials of the traditional door and window are directly communicated indoors and outdoors, which results in the reduction of the thermal insulation performance of the door and window.

Additionally, the first fixing parts and the second fixing parts of the above door and window insulation structure are staggered, which solves the problem of the direct heat radiation due to the formation of the cavity between the side frame and the door and window of the traditional door and window This door and window insulation structure solves the problem that the traditional door and window has the cavities formed between the side frame and the door and window, which results in the poorer thermal insulation performance of the door and window.

### BRIEF DESCRIPTION OF DRAWINGS

The present disclosure can be further understood from the following description in conjunction with the drawings. The components in the drawings are not necessarily drawn to scale, but rather the emphasis is placed on illustrating the principles of the embodiments. In different views, the same reference numbers denote the corresponding parts.

FIG. 1 is one of the partial schematic structure diagrams of an insulation structure described in an embodiment of the present disclosure;

FIG. 2 is another partial schematic structure diagram of an insulation structure described in an embodiment of the present disclosure;

FIG. 3 is another partial schematic structure diagram of an insulation structure described in an embodiment of the present disclosure;

FIG. 4 is another partial schematic structure diagram of an insulation structure described in an embodiment of the present disclosure;

FIG. 5 is an enlarged diagram of Part A of FIG. 4;

FIG. 6 is one of the schematic structure diagrams of a compensating member of an insulation structure described in an embodiment of the present disclosure;

FIG. 7 is another schematic structure diagram of a compensating member of an insulation structure described in an embodiment of the present disclosure;

FIG. 8 is one of the schematic structure diagrams of a door and window insulation structure described in an embodiment of the present disclosure;

FIG. 9 is another schematic structure diagram of a door and window insulation structure described in an embodiment of the present disclosure;

FIG. 10 is an enlarged diagram of Part A of FIG. 9;

FIG. 11 is an enlarged diagram of Part C of FIG. 10;

FIG. 12 is a partial schematic structure diagram of a door and window insulation structure described in an embodiment of the present disclosure; and

FIG. 13 is an enlarged diagram of Part B of FIG. 12

### REFERENCE NUMBERS

1—main—body assembly; 11—first main body; 12—middle frame; 13—second main body; 2—side frame; 21—frame body; 22—thermal insulation assembly; 221—first sectional material; 222—compensating member; 223—second sectional material; 224—locking member; 3—thermal insulation cavity; 23—first fixing part; 24—first insertion part; 4—main body portion; 14—second fixing part; 15—second insertion part; 16—sealing member; 5—adhesive strip assembly; 51—first sealing part; and 52—second sealing part.

### DETAILED DESCRIPTION OF EMBODIMENTS

In order to make the objects, technical solutions, and advantages of the present disclosure clearer and more understandable, the present disclosure is described in further detail below in conjunction with embodiments. It should be understood that the specific embodiments described herein are used only to explain the present disclosure and are not intended to limit the scope of the protection of the present disclosure.

It should be noted that when a component is referred to be “fixed” to the other component, it can be directly arranged on the other component, or a centered component can exist. When a component is considered to be “connected” to the other component, it can be directly connected to the other component, or a centered component may exist at the same time. The terms “vertical”, “horizontal”, “left”, “right”, and similar expressions used herein are only illustrative, and are not intended to be exclusive.

Unless otherwise defined, all technical and scientific terms used herein have the same meaning as commonly understood by those skilled belonging to the technical field of the present disclosure. The terms used herein in the specification of the present disclosure are only to describe specific embodiments and are not intended to limit the present disclosure. The term “and/or” used herein includes any and all combinations of one or more of the relevant listed items.

The terms “first” and “second” in the present disclosure do not represent specific quantities or orders, but are merely used for differentiating names.

In order to solve the above technical problems, the present disclosure provides an insulation structure and a door and window insulation structure. The specific technical solutions are as follows.

In a first aspect, the present disclosure provides an insulation structure, including:

a main-body assembly; and

a side frame, wherein the side frame includes a frame body and a thermal insulation assembly arranged in the frame body; the thermal insulation assembly includes a first sectional material, a compensating member, and a second sectional material connected in sequence; the main-body assembly is arranged on the frame body; and the thermal insulation assembly is arranged in a length direction of the frame body, wherein the first sectional material is located indoors, and the second sectional material is located outdoors.

In some embodiments, the main-body assembly includes a first main body, a middle frame, and a second main body connected in sequence, and the first main body, the middle frame, and the second main body are all arranged on the frame body.

In some embodiments, a first space is arranged in the frame body; the middle frame is vertically arranged on the frame body; and the middle frame divides the first space into a first mounting space and a second mounting space.

In some embodiments, the first main body is arranged in the first mounting space; the second main body is arranged in the second mounting space; and the first main body is staggered with the second main body in an X-axis direction.

In some embodiments, the main-body assembly includes a plurality of sliding members, and the plurality of sliding members are all arranged on the frame body and slidingly connected to the frame body.

In some embodiments, when the main-body assembly is closed, the first sectional material is located indoors, and the second sectional material is located outdoors.

In some embodiments, the thermal insulation assembly further includes a locking member, wherein the locking member passes through the compensating member and the frame body, and the locking member is threadedly connected to the compensating member and the frame body respectively.

In some embodiments, the compensating member is provided therein with a thermal insulation cavity.

In a second aspect, the present disclosure further provides a door and window insulation structure, including:

a side frame; and

a main body portion, wherein the main body portion is arranged on the side frame and slidingly connected to the side frame; the side frame includes a frame body and a plurality of first fixing parts arranged at intervals and all arranged on the frame body; and the main body portion includes a main body (the main-body assembly) and a plurality of second fixing parts arranged at intervals and all arranged on the main body, wherein one of the first fixing parts is correspondingly inserted between two adjacent second fixing parts, and one of the second fixing parts is correspondingly inserted between two adjacent first fixing parts.

In some embodiments, the main body portion further includes a sealing member, and the sealing member is arranged on a side surface of the main body (the main-body assembly).

In some embodiments, an adhesive strip assembly is arranged on the side frame; when the main body portion is closed, a first cavity is formed between the frame body, the adhesive strip assembly, the sealing member, and the main body (the main-body assembly); and the first fixing part and the second fixing part are both arranged in the first cavity.

In some embodiments, the adhesive strip assembly includes a first adhesive strip and a second adhesive strip, wherein the first adhesive strip includes a first connection part and a plurality of first sealing parts arranged at intervals and all arranged on the first connection part, and the second adhesive strip includes a second connection part and a plurality of second sealing parts arranged at intervals and all arranged on the second connection part.

In some embodiments, the first sealing parts and the second sealing parts are made of a soft material.

In some embodiments, one first sealing part is correspondingly inserted between two adjacent second sealing parts, and one second sealing part is correspondingly inserted between two adjacent first sealing parts.

In some embodiments, the frame body includes the frame and a first insertion part, wherein the frame is provided with a first C-shaped groove; the first insertion part is inserted in the first C-shaped groove; and the plurality of first fixing parts are all arranged on the first insertion part.

In some embodiments, the main body (the main-body assembly) includes a body and a second insertion part, wherein the body is provided with a second C-shaped groove; the second insertion part is inserted in the second C-shaped groove; and the plurality of second fixing parts are all arranged on the second insertion part.

In the above insulation structure, the first sectional material and the second sectional material are disconnected by the compensating member, which avoids the direct heat transfer between the first sectional material and the second sectional material, so as to solve the problem that the partial sectional materials of the traditional door and window are directly communicated indoors and outdoors, which results in the reduction of the thermal insulation performance of the door and window.

Additionally, the first fixing parts and the second fixing parts of the above door and window insulation structure are staggered, which solves the problem of the direct heat radiation due to the formation of the cavity between the side frame and the door and window of the traditional door and window This door and window insulation structure solves the problem that the traditional door and window has the cavities formed between the side frame and the door and window, which results in the poorer thermal insulation performance of the door and window.

In order to make the above purposes, features, and advantages of the present disclosure more obvious and easy to understand, the following is a detailed description of preferred embodiments in conjunction with the drawings.

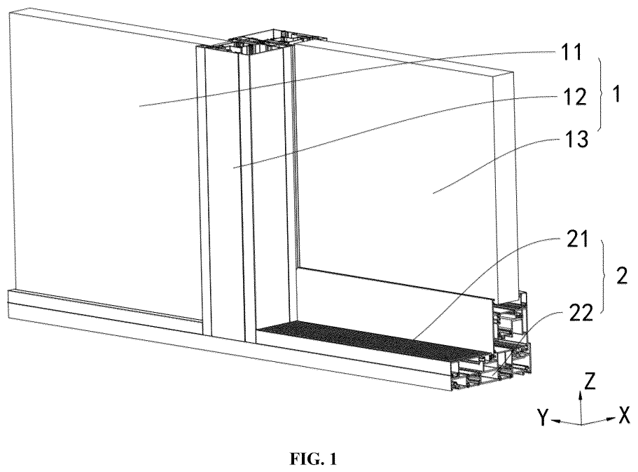

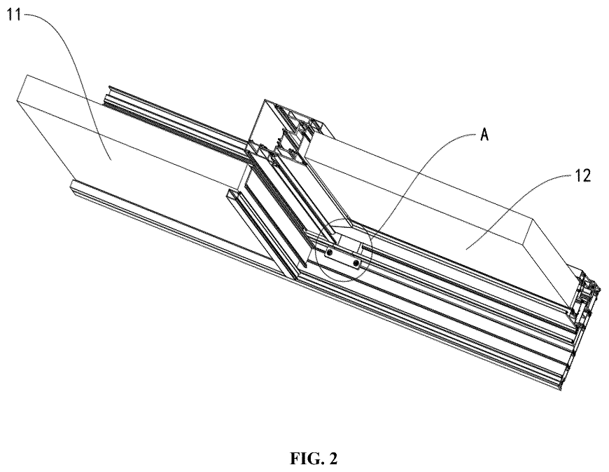

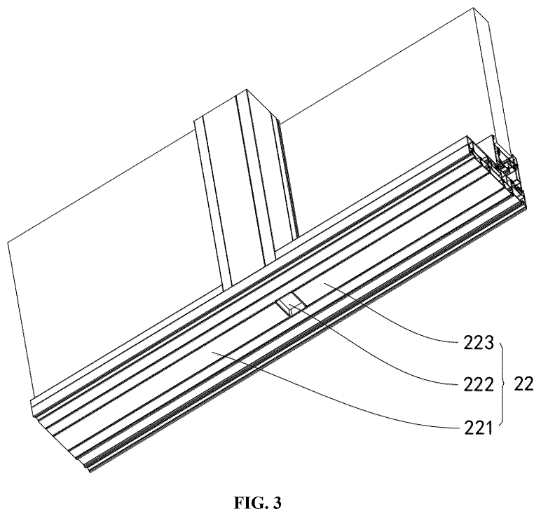

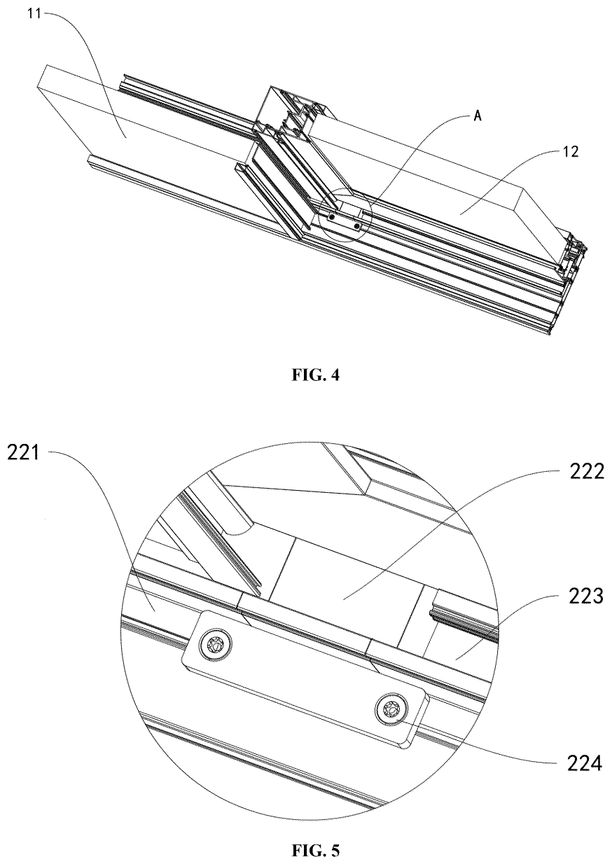

As shown in FIG. 1˜FIG. 4, an insulation structure in one embodiment of the present disclosure includes a main-body assembly 1 and a side frame 2, wherein the side frame 2 includes a frame body 21 and a thermal insulation assembly 22 arranged in the frame body 21; the thermal insulation assembly 22 includes a first sectional material 221, a compensating member 222, and a second sectional material 223 connected in sequence; the main-body assembly 1 is arranged on the frame body 21; and the thermal insulation assembly 22 is arranged in a length direction of the frame body 21, wherein the first sectional material 221 is located indoors, and the second sectional material 223 is located outdoors.

In the above insulation structure, the first sectional material 221 and the second sectional material 223 are disconnected by the compensating member 222, which avoids the direct heat transfer between the first sectional material 221 and the second sectional material 223, so as to solve the problem that the partial sectional materials of the traditional door and window are directly communicated indoors and outdoors, which results in the reduction of the thermal insulation performance of the door and window.

As shown in FIG. 1˜FIG. 4, in one embodiment, the main-body assembly 1 includes a first main body 11, a middle frame 12, and a second main body 13 connected in sequence; the first main body 11, the middle frame 12, and the second main body 13 are all arranged on the frame body 21; a first space is arranged in the frame body 21; the middle frame 12 is vertically arranged on the frame body 21; the middle frame 12 divides the first space into a first mounting space and a second mounting space; the first main body is arranged in the first mounting space; the second main body is arranged in the second mounting space; and the first main body is staggered with the second main body in an X-axis direction. In this way, the first sectional material 221 and the second sectional material 223 are disconnected by the compensating member 222, which avoids the direct heat transfer between the first sectional material 221 and the second sectional material 223, so as to avoid the phenomenon of fast heat transfer between the first mounting space and the second mounting space.

In one embodiment, the main-body assembly 1 includes a plurality of sliding members, and the plurality of sliding members are all arranged on the frame body 21 and slidingly connected to the frame body 21. When the main-body assembly 1 is closed, the first sectional material 221 is located indoors, and the second sectional material 223 is located outdoors. In this way, when the main body assembly 1 is closed, the first sectional material 221 and the second sectional material 223 are disconnected by the compensating member 222, which avoids the fast heat transfer between the indoor and the outdoor by the insulation assembly 22.

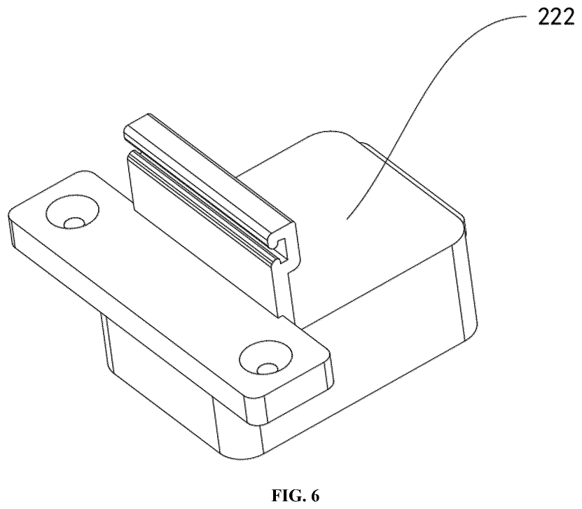

As shown in FIG. 5, in one embodiment, the thermal insulation assembly 22 further includes a locking member 224, wherein the locking member 224 passes through the compensating member 222 and the frame body 21, and the locking member 224 is threadedly connected to the compensating member 222 and the frame body 21 respectively. In this way, the compensating member 222 is fixed to the frame body 21 by providing the locking member 224.

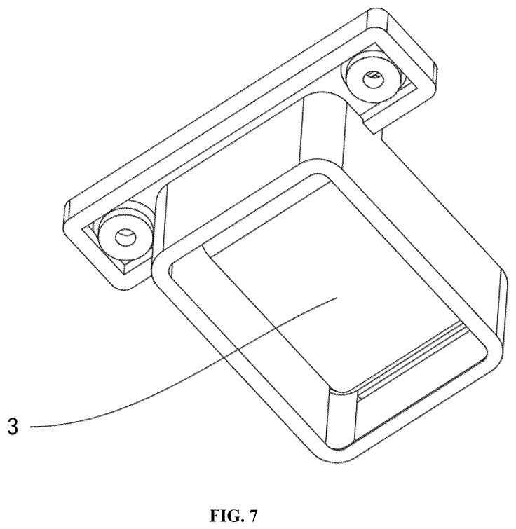

As shown in FIG. 6˜FIG. 7, in one embodiment, the compensating member 222 is provided therein with a thermal insulation cavity 3. In this way, the thermal insulation effect of the compensating member 222 is improved by providing the thermal insulation cavity 3.

In one embodiment, the compensating member 222 is made of the insulating material.

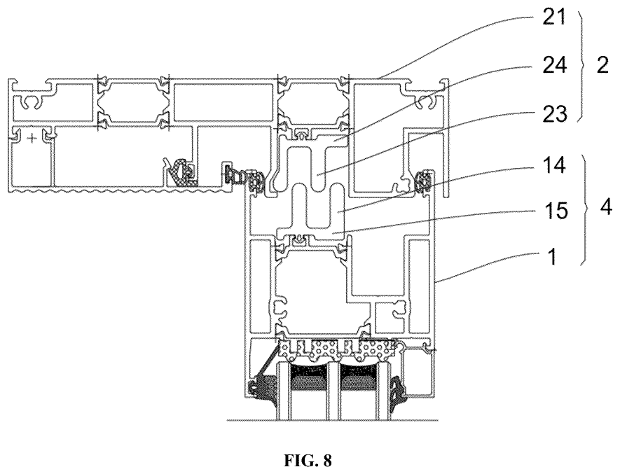

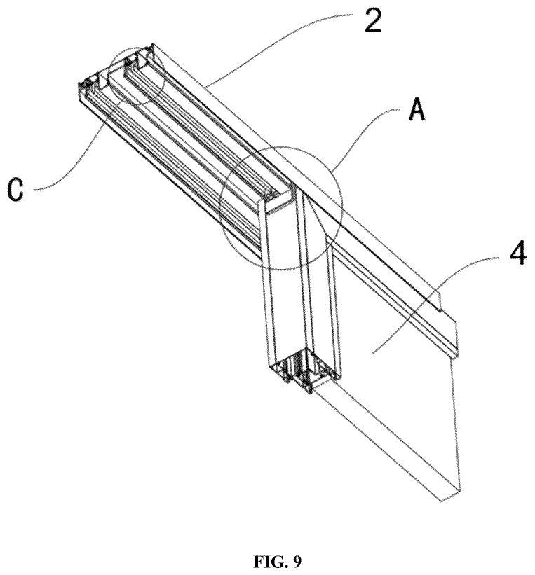

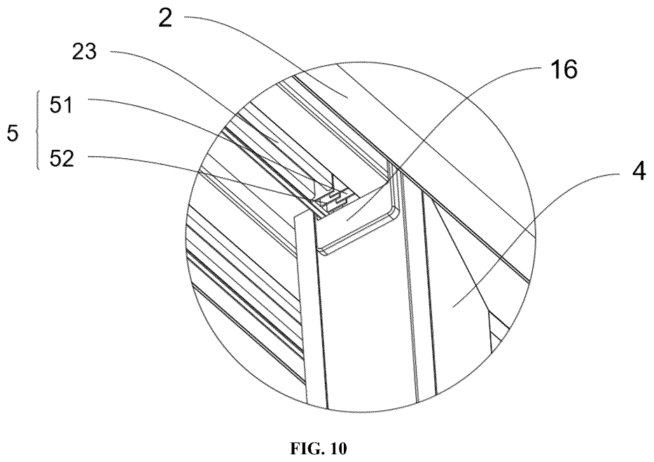

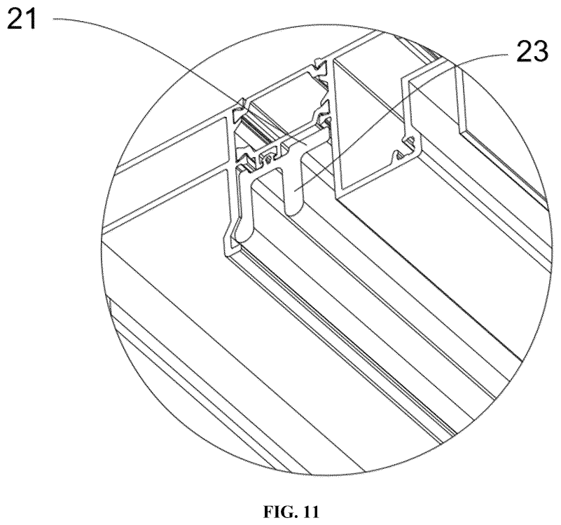

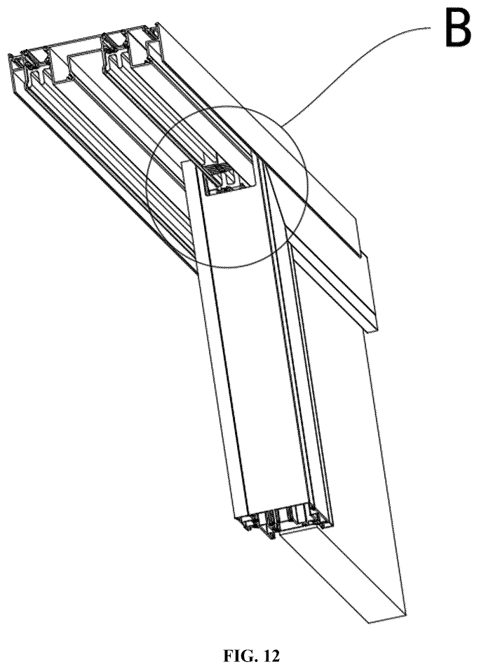

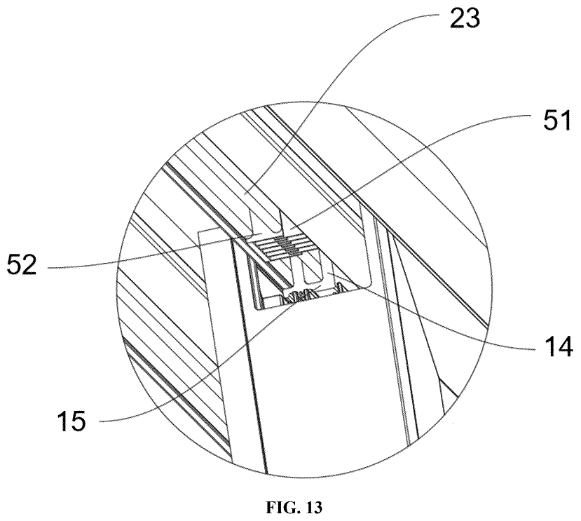

As shown in FIG. 8, a door and window insulation structure in one embodiment of the present disclosure includes the side frame 2 and the main body portion 4, wherein the main body portion 4 is arranged on the side frame 2 and slidingly connected to the side frame 2; the side frame 2 includes the frame body 21 and the plurality of first fixing parts 23 arranged at intervals and all arranged on the frame body 21; and the main body portion 4 includes the main body (the main-body assembly) 1 and the plurality of second fixing parts 14 arranged at intervals and all arranged on the main body (the main-body assembly) 1, wherein one of the first fixing parts 23 is correspondingly inserted between two adjacent second fixing parts 14, and one of the second fixing parts 14 is correspondingly inserted between two adjacent first fixing parts 23.

As shown in FIG. 8˜FIG. 13, in the above door and window insulation structure, the main body portion 4 further includes a sealing member 16; the sealing member 16 is arranged on a side surface of the main body 1; an adhesive strip assembly 5 is arranged on the side frame 2; when the main body portion 4 is closed, a first cavity is formed between the frame body 21, the adhesive strip assembly 5, the sealing member 16, and the main body (the main-body assembly) 1; and the first fixing part 23 and the second fixing part 14 are both arranged in the first cavity. In this way, by forming the first cavity, a large amount of outdoor air is prevented from directly entering between the main body portion 4 and the side frame 2, and the thermal insulation performance of the door and window thermal insulation structure is improved.

As shown in FIG. 8˜FIG. 13, in one embodiment, the adhesive strip assembly 5 includes a first adhesive strip and a second adhesive strip, wherein the first adhesive strip includes a first connection part and a plurality of first sealing parts 51 arranged at intervals and all arranged on the first connection part, and the second adhesive strip includes a second connection part and a plurality of second sealing parts 52 arranged at intervals and all arranged on the second connection part, wherein one first sealing part 51 is correspondingly inserted between two adjacent second sealing parts 52; one second sealing part 52 is correspondingly inserted between two adjacent first sealing parts 51; and the first sealing parts 51 and the second sealing parts 52 are made of a soft material. In this way, when the main body portion 4 slides, the second fixing part 14 collides with the adhesive strip assembly 5. Since the first sealing part 51 and the second sealing part 52 are made of the soft material, then the first sealing part 51 and the second sealing part 52 deform, which facilitates the reciprocal movement of the main body and the adhesive strip assembly 5 at two sides. By providing the first sealing part 51 and the second sealing part 52, the sealing performance inside the first cavity is improved.

As shown in FIG. 8, in one of the embodiments, the frame body 21 includes the frame and a first insertion part 24, wherein the frame is provided with a first C-shaped groove; the first insertion part 24 is inserted in the first C-shaped groove; and the plurality of first fixing parts 23 are all arranged on the first insertion part 24; the main body (the main-body assembly) 1 includes a second insertion part 15 and the body, wherein the body is provided with a second C-shaped groove; the second insertion part 15 is inserted in the second C-shaped groove; and the plurality of second fixing parts 14 are all arranged on the second insertion part 15.

The various technical features of the above embodiments can be combined arbitrarily. For the sake of brevity, all possible combinations of the technical features in the above embodiments are not described. However, if there is no contradiction in the combinations of these technical features, they should be considered to be within the scope of the specification.

The above embodiments only show several embodiments of the present disclosure, and their descriptions are more specific and detailed, but cannot therefore be understood as limiting the scope of the present disclosure. It should be noted that for a person of ordinary skill in the art, several deformations and improvements can be made without departing from the conception of the present disclosure, all of which fall within the scope of protection of the present disclosure. Therefore, the scope of the protection of the present disclosure shall be subject to the scope of the claims attached.

### INDUSTRIAL APPLICABILITY

In the insulation structure and the door and window insulation structure provided by the present disclosure, the first sectional material and the second sectional material are disconnected by the compensating member, which avoids the direct heat transfer between the first sectional material and the second sectional material, so as to solve the problem that the partial sectional materials of the traditional door and window are directly communicated indoors and outdoors, which results in the reduction of the thermal insulation performance of the door and window. Additionally, the first fixing parts and the second fixing parts are staggered, which solves the problem of the direct heat radiation due to the formation of the cavity between the side frame and the door and window of the traditional door and window This door and window insulation structure solves the problem that the traditional door and window has the cavities formed between the side frame and the door and window, which results in the poorer thermal insulation performance of the door and window.

Furthermore, it will be appreciated that the insulation structure and the door and window insulation structure provided by the embodiments of the present disclosure is reproducible, and can be applied in a variety of industrial applications. For example, the insulation structure and the door and window insulation structure provided by embodiments of the present disclosure can be applied in the field involving the door and window manufacturing.

What is claimed is:

1. An insulation structure, comprising:
a main-body assembly; and
a side frame, wherein the side frame comprises a frame body and a thermal insulation assembly arranged in the frame body; the thermal insulation assembly comprises a first sectional material, a compensating member, and a second sectional material connected in sequence; the main-body assembly is arranged on the frame body; and the thermal insulation assembly is arranged in a length direction of the frame body, wherein the first sectional material is located indoors, and the second sectional material is located outdoors.

2. The insulation structure according to claim 1, wherein the main-body assembly comprises a first main body, a middle frame, and a second main body connected in sequence, and the first main body, the middle frame, and the second main body are all arranged on the frame body.

3. The insulation structure according to claim 2, wherein a first space is arranged in the frame body; the middle frame is vertically arranged on the frame body; and the middle frame divides the first space into a first mounting space and a second mounting space.

4. The insulation structure according to claim 3, wherein the first main body is arranged in the first mounting space; the second main body is arranged in the second mounting space; and the first main body is staggered with the second main body in an X-axis direction.

5. The insulation structure according to claim 1, wherein the main-body assembly comprises a plurality of sliding members, and the plurality of sliding members are all arranged on the frame body and slidingly connected to the frame body.

6. The insulation structure according to claim 5, wherein when the main-body assembly is closed, the first sectional material is located indoors, and the second sectional material is located outdoors.

7. The insulation structure according to claim 1, wherein the thermal insulation assembly further comprises a locking member, wherein the locking member passes through the compensating member and the frame body, and the locking member is threadedly connected to the compensating member and the frame body respectively.

8. The insulation structure according to claim 1, wherein the compensating member is provided therein with a thermal insulation cavity.

9. A door and window insulation structure, comprising:
a side frame; and
a main body portion, wherein the main body portion is arranged on the side frame and slidingly connected to the side frame; the side frame comprises a frame body and a plurality of first fixing parts arranged at intervals and all arranged on the frame body; and the main body portion comprises a main body and a plurality of second fixing parts arranged at intervals and all arranged on the main body, wherein one of the first fixing parts is correspondingly inserted between the two adjacent second fixing parts, and one of the second fixing parts is correspondingly inserted between the two adjacent first fixing parts.

10. The door and window insulation structure according to claim 9, wherein the main body portion further comprises a sealing member, and the sealing member is arranged on a side surface of the main body.

11. The door and window insulation structure according to claim 10, wherein an adhesive strip assembly is arranged on the side frame; when the main body portion is closed, a first cavity is formed between the frame body, the adhesive strip assembly, the sealing member, and the main body; and the first fixing part and the second fixing part are both arranged in the first cavity.

12. The door and window insulation structure according to claim 11, wherein the adhesive strip assembly comprises a first adhesive strip and a second adhesive strip, wherein the first adhesive strip comprises a first connection part and a plurality of first sealing parts arranged at intervals and all arranged on the first connection part, and the second adhesive strip comprises a second connection part and a plurality of second sealing parts arranged at intervals and all arranged on the second connection part.

13. The door and window insulation structure according to claim 12, wherein the first sealing parts and the second sealing parts are made of a soft material.

14. The door and window insulation structure according to claim 12, wherein one of the first sealing parts is correspondingly inserted between the two adjacent second sealing parts, and one of the second sealing parts is correspondingly inserted between the two adjacent first sealing parts.

15. The door and window insulation structure according to claim 9, wherein the frame body comprises a frame and a first insertion part, wherein the frame is provided with a first C-shaped groove; the first insertion part is inserted in the first C-shaped groove; and the plurality of first fixing parts are all arranged on the first insertion part.

16. The door and window insulation structure according to claim 9, wherein the main body comprises a body and a second insertion part, wherein the body is provided with a second C-shaped groove; the second insertion part is inserted in the second C-shaped groove; and the plurality of second fixing parts are all arranged on the second insertion part.
